(19) United States
(12) Patent Application Publication
(10) Pub. No.: US 2016/0103613 A1
(43) Pub. Date: Apr. 14, 2016

(54) TAGGING FOR STORAGE DEVICE REGIONS

(71) Applicant: Microsoft Corporation, Redmond, WA (US)

(72) Inventors: Jacob Oshins, Seattle, WA (US); John Starks, Seattle, WA (US)

(73) Assignee: Microsoft Corporation

(21) Appl. No.: 14/512,476

(22) Filed: Oct. 13, 2014

(51) Int. Cl. G06F 3/06

(52) U.S. Cl. CPC G06F 3/064; G06F 3/061; G06F 3/0683

(57) ABSTRACT

A computing device manages access to a block-based storage device. The computing device has an operating system with a storage stack. The storage stack may have a file system, a device driver driving the block-based storage device, and a storage component intermediating between the device driver and the file system. The file system may receive a request to tag a file that is managed by the file system and is stored on the storage device. In response the file system requests the storage component to tag blocks corresponding to the file. The device driver forwards or translates the request from the storage component to the storage device. In turn, the storage device stores indicia of the blocks. Data stored in the identified blocks may receive differentiated treatment, by the storage device and/or the operating system, such as a particular choice of backing store, preferential handling, or others.

### BACKGROUND

There are many known ways for operating systems to manage block-based storage devices such as disk drives, virtual disks, storage area network (SAN) disks, etc. Typically, an operating system provides a storage stack, which may include a file system and one or more layers and drivers intermediating exchanges between the file system and a storage device. The file system provides organization and structure to data stored in the storage device, other layers of storage stack handle exchanges between the file system and the storage device, and the storage device stores the data in blocks and provides related storage management functionality. For example, an operating system might have an ext3 file system, a SCSI (Small Computer System Interface) subsystem, and a SCSI disk drive, cooperating in known fashion.

Recently, virtual devices have become a common substitute for hardware storage devices such as hard drives. Most implementations of virtual disks or virtual storage devices use a special type of container or file that acts as the backing store for a corresponding virtual disk (to be referred to as a “storage device”, a term used herein to refer to both physical and virtual block-based storage devices), such as the Virtual Hard Disk (VHD) format, the Virtual Machine Disk (VMDK) format, the Virtual Desktop Infrastructure (VDI) format, and others.

Certain usage scenarios of storage devices, both virtual and non-virtual, give rise to inefficiencies. For instance, often times a storage device is called upon to store data that may or may not require persistence across events such as operating system crashes, operating system reboots, storage device duplication, backups, etc. However, previous storage devices and supporting operating system storage stacks have treated all stored data as equivalent. For example, a video editing application might have a large storage space reserved for “scratch” temporary storage of data.

Consider a machine with an operating system. The operating system may have a paging or swap file. To free up memory, code and data that are not in use by the operating system may be written to the swap file, which is usually stored on a disk (in this example, the “disk” could also be a virtual disk, or any other block-based device). The data in the swap file may be faulted back into memory as necessary. When the machine is rebooted, the contents of the swap file usually become irrelevant, as the file's content is temporary. However, operating systems have treated I/O (input/output) to the operating system's swap file in nearly the same way all other disk I/O has been treated. That is, the operating system may ensure, without regard for the nature of data being stored: that writes to the swap file are stored to disk, that swap file I/O is properly ordered with other I/O transactions, etc. In addition, the swap file on the disk might be treated in the same way as any other data on that disk. For instance, the swap file is backed up when the disk is backed up and the swap file is transferred over a network when the disk copied across the network (e.g., when a virtual machine (VM) is replicated or migrated).

Generally, storage systems treat all data as equivalent and fail to address various storage-related inefficiencies. Techniques described herein relate to enabling differentiated storage for block-based storage devices.

### SUMMARY

The following summary is included only to introduce some concepts discussed in the Detailed Description below. This summary is not comprehensive and is not intended to delineate the scope of the claimed subject matter, which is set forth by the claims presented at the end.

A computing device manages access to a block-based storage device. The computing device has an operating system with a storage stack. The storage stack may have a file system, a device driver driving the block-based storage device, and a storage component (described below) intermediating between the device driver and the file system. The file system may receive a request to tag a file that is managed by the file system and is stored on the storage device. In response the file system requests the storage component to tag blocks corresponding to the file. The device driver forwards or translates the request from the storage component to the storage device. In turn, the storage device stores indicia of the blocks. Data stored in the identified blocks may receive differentiated treatment, by the storage device and/or the operating system, such as a particular choice of backing store, preferential handling, or others.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows storage features of a computing device.

FIG. 2 shows a storage system augmented to facilitate differentiated treatment of storage regions in a storage device.

FIG. 3 shows an example of a storage device.

FIG. 4 shows steps for handling writes to a file tagged for differentiated storage.

FIG. 5 shows a storage device receiving a write request.

FIG. 6 shows details of a computing device.

### DETAILED DESCRIPTION

Embodiments discussed below relate to differentiated storage in block-based storage devices. Discussion will begin with an architectural overview. General processes for setting up and implementing differentiated storage will be described next. Implementation details for different storage standards will be describe next, followed by discussion of usage scenarios and performance enhancements for differentiated storage.

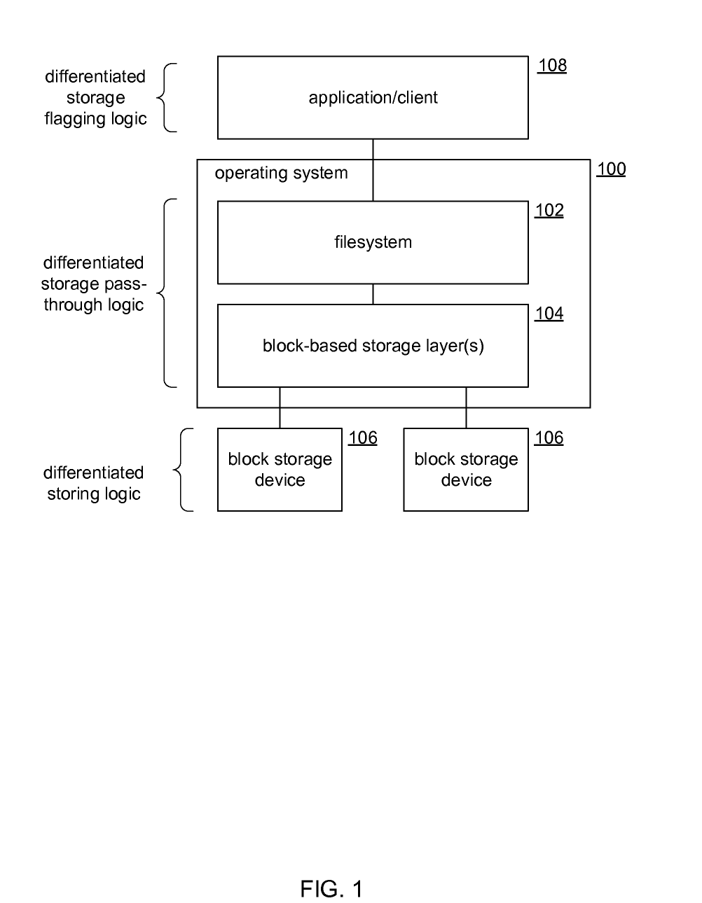

FIG. 1 shows storage features of a computing device. An operating system 100 may have a storage stack that includes layers such as a file system 102 and one or more block-based storage layers 104 that are part of the operating system 100's storage stack providing I/O services for block-based storage devices 106 (as noted above, a “storage device” as used herein may be any virtual or hardware block-based storage device managed by the operating system). The file system 102 may be any known type of file system modified as indicated herein. The storage layers 104 may be any of a variety of intermediation modules or layers used by different operating systems to facilitate I/O with storage devices. Some operating systems have complex storage stacks with multiple layers (e.g., a disk layer, a partition layer, a virtual disk layer, etc.) and pluggable filters, whereas other operating systems may have simple storage stacks such as a SCSI subsystem, a SATA (Serial Advanced Technology Attachment) driver, etc. Storage layers 104 will usually include device drivers for the respective block storage devices 106.

As noted above, the block based storage devices 106 may be either hardware devices or virtual devices. A hardware storage device, such as a disk drive or flash drive, will have an interface to communicate with the host computing device via a physical bus, a wireless link, etc. Virtual storage devices may connect through a virtual bus or other hypervisor-provided communication channel. A storage device can also be a SAN (storage area network) disk provided via a protocol such as iSCSI (Internet SCSI). In any case, the operating system 100 will provide necessary interfaces and drivers for communicating with the storage devices.

FIG. 1 also shows an application or client 108 communicating with the file system 102. The client 108 may be any code running on the machine hosting the operating system 100. The client 108 may be either user mode or kernel mode code. The client 108 may use APIs (application programming interfaces) provided by the operating system 100 to interact with the file system 102 and, indirectly, the storage devices 106. The client 108 may be code that is part of the operating system, for instance memory manager code that manages a swap file, boot code, etc. The client 106 may also be an application installed to run on the host computing device, for instance a multimedia application, a backup program, or any other arbitrary software. To store and retrieve data, the client 108 interacts with the file system 102 via the corresponding API, and may issue various file-related commands such as opening files, creating files, writing to files, copying files, reading from a file, setting permissions for files, closing files, and others. As will be described next, the client 108 may also issue a command to tag or categorize a region of storage in a storage device for differentiated treatment by the operating system and/or a corresponding storage device.

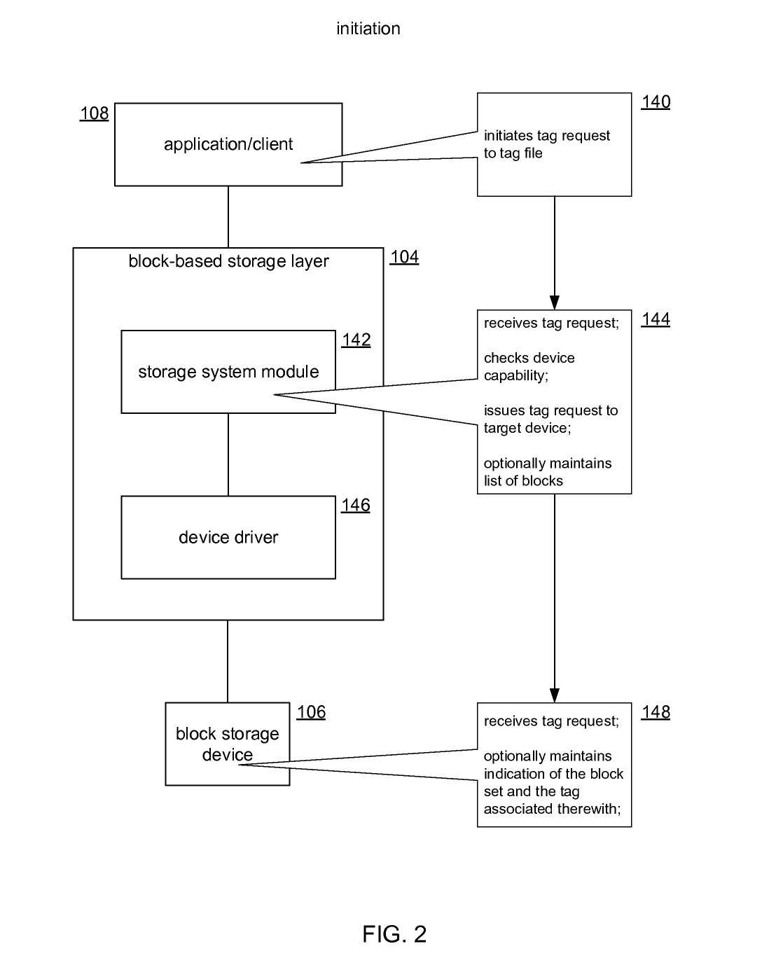

FIG. 2 shows a storage system augmented to facilitate differentiated treatment of storage regions in a storage device 106. It will be assumed that the client 108 has a file system object, such as a file, ready to be tagged. For example using a file system API, the client 108 may have created or trimmed a file such as a swap file or other file to be tagged for differentiated storage. At step 140, the client 108 initiates tagging of the file. This may be done with any suitable extension to the operating system's file system API, for instance, a special file control flag may be added. For example, in a Unix type of operating system, an fsctl( ) option may be added. In a Microsoft Windows™ system, a new FSCTL (file system control) flag may be added. In another embodiment, the file may be a new special type of file system object, e.g., a special file, designated when the file is created. Regardless of the mechanism by which the client 108 interfaces with the file system to inform the file system that the file is to be tagged for differential storage treatment, the initial tagging request to the file system will include an identifier for the target file (e.g., with a file handle or descriptor). As part of the request handling process, the file system uses the file identifier to obtain block identifiers of the blocks in the target storage device that store the target file (block identifiers may be implicitly represented, e.g., as a range or an extent). In turn, the file system propagates the initial request by passing indicia of the blocks and the tag operation down the storage stack.

At step 144, the propagated (perhaps translated) tag request is received at a storage layer 104 below the file system. For example, the storage layer 104 may have a storage system module 142, which in this description represents any component found in a storage stack of an operating system. For example, the storage system module 142 might be a disk virtualization component that parses virtual disk files (e.g., VHD, VMDK, VDI, etc.) and provides them as virtual disk drives. The storage system module 142 can be implemented as a special device driver, a shim in the operating system's storage stack, part of a SCSI layer or subsystem connecting SCSI clients and targets, etc. In any case, the storage system module 142, at step 144, receives the tag request. Because in some implementations differentiated storage might not be supported at lower levels of the storage stack such as a device driver or the target storage device, the storage system module 142 may check down the stack for support for the tagging request. In a SCSI implementation, for example, this might involve sending a vital product data (VDP) request to the target storage device's device driver 146, which in turn may query the target storage device 106. The storage system module 142 then checks the VDP to determine if differentiated storage is supported. Note that this compatibility check is not required; an error handling process, for example, can deal with any incompatibility faults. Ignoring possible incompatibility may be particularly feasible in implementations where lack of differentiated storage support only results in the default action of storing data in an ordinary undifferentiated manner.

The storage system module 142 may translate the received request into a format suitable for the next layer of the storage stack. For example, the tagging request may be issued as a SATA or SCSI command (e.g., a new command, a new parameter of an existing command such as a SCSI “mode select”, etc.). The storage system module 142 then sends the tag request down the storage stack, which, either directly or indirectly, is received by the device driver 146 which passes the request or command to the target storage device 106 for implementation.

To summarize, the storage system module 142 may be any component of the operating system that intermediates exchanges storage requests, including tagging requests, between initiators/clients and storage devices. The storage system module 142 may or may not include multiple discrete storage layers, depending on implementation. The storage system module 142 may provide an interface between user space and the kernel. The storage system module 142 may also function as a traffic director, routing exchanges between storage devices and initiators, possibly translating between APIs or protocols as exchanges are passed to and from storage devices. The storage system module may perform other functions besides handling I/O requests, such as managing command queues, handling errors, managing power for storage devices, etc.

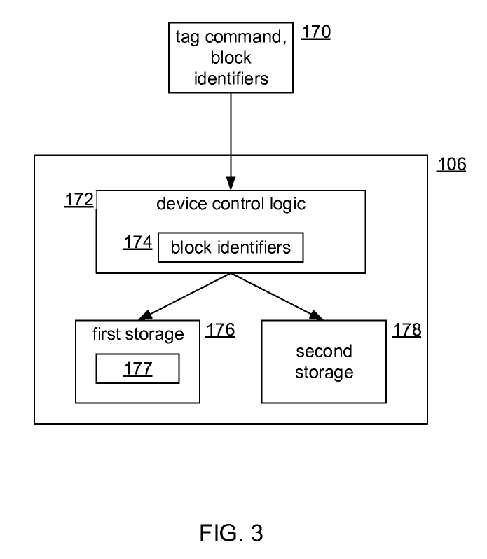

FIG. 3 shows an example of the target storage device 106. Optionally, depending on the implementation, at step 148, the target storage device receives the tag request 170 and control logic 172 stores the block identifiers 174 designated for differentiated storage (block identifiers may be encoded as ranges, lists of extents, etc.). Other management steps may be performed at this time. For example, the control logic 172 may reserve appropriate space, set up a new section or element of backing store, request a unit of storage from a SAN server, and so on. In an implementation where the storage device is a virtual drive, several approaches may be used. First, within a single virtual disk image file (e.g., a VHD file), blocks or a region may be reserved (logically or physically). Second, a separate virtual disk image file may be created specifically for the designated blocks. In an embodiment where the target storage device is a virtualized disk backed by multiple storage devices (e.g., a SAN disk, a concatenated set of storage devices, etc.), the storage unit to be used (e.g., the backing store) may be selected based on the fact that the blocks have been tagged for differentiated storage. For example, if the target storage device has a volatile storage component (e.g., a RAM (random access memory) disk), that storage component may be selected for storing the tagged blocks. In the example of FIG. 3, the first storage 176 is a storage region, device, etc. that is to store the tagged blocks for the file 177, and the second storage 178 is for other non-tagged blocks. In one embodiment, the one embodiment the first storage 176 stores only and all of the blocks of the file being tagged, and the second storage 178 stores no blocks of the file being tagged. In sum, the target storage device's control logic 172 may determine how to store the blocks based on the fact that the blocks have been tagged for differentiated storage. The region or unit of media designated for storing the blocks, as well as the block identifiers 174 may then be used during write or store operations directed to the corresponding file (and consequently, the block identifiers 174 for the file).

Indicia of the target blocks may be maintained at any of one or more places in the storage stack, including the target storage device, and no particular element of the storage stack is required to maintain indicia of the target blocks. That is, step 144 and step 148, to the extent they are performed, may be performed anywhere in a path through the storage stack from the file system to the target storage device.

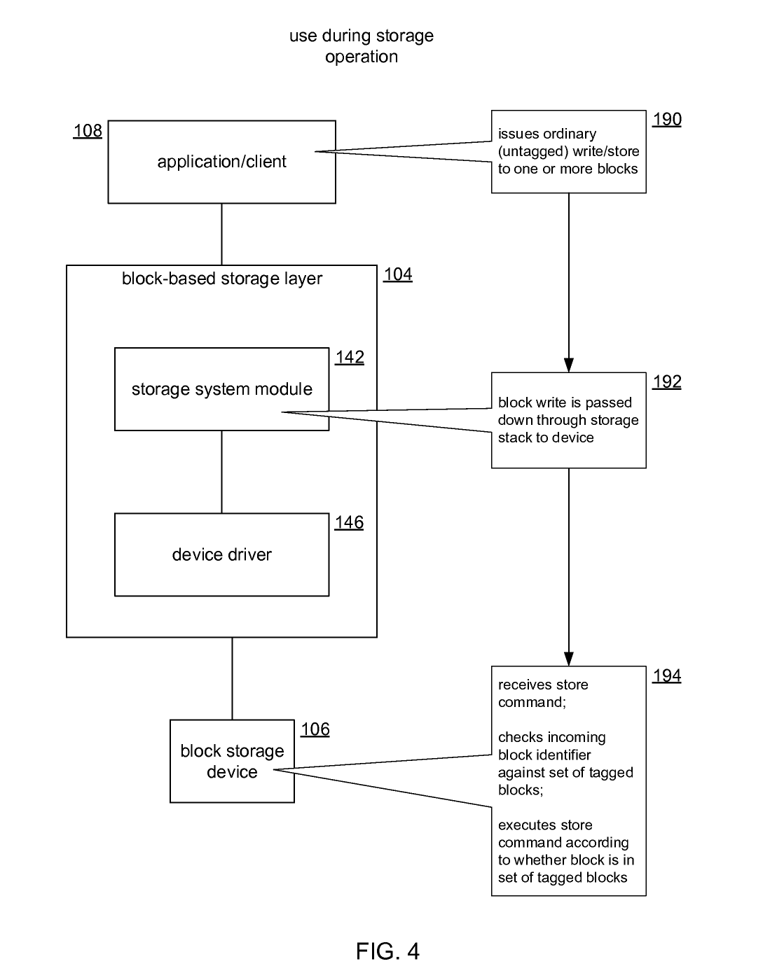

FIG. 4 shows steps for handling writes to the file tagged for differentiated storage. At step 190 the client 108 issues to the file system an ordinary write command to store data in the previously tagged file. As with any write command, the file system passes on the write request to be carried out by the target storage device and possibly other elements of the storage stack. This may involve identifying the blocks to be written. In some operating systems, writes to special files such as swap files, for speed, may not traverse the operating system's full storage stack and instead, for example, may be passed directly to the device driver 146 of the block storage device (or, may not pass through the file system). In one embodiment, at step 192, the write request is passed on, perhaps with translation to a write command of a storage standard (e.g., SCSI, SATA), and is received by the target storage device at step 194.

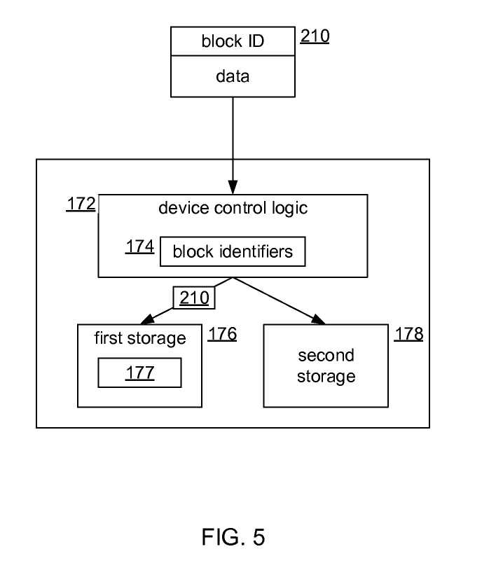

FIG. 5 shows the target storage device receiving the write request 210, which includes identifiers of the blocks to be written and data for the blocks. At step 194 (FIG. 4) the control logic 172 of the storage device compares the incoming block identifiers against the stored block identifiers 174 that represent the tagged blocks. Based on the block identifiers being in the set of stored block identifiers 174, the blocks are stored in the appropriate region, storage unit, backing store etc., for instance, the first storage 176. If the incoming block identifiers are not in the set of stored block identifiers 174, then the blocks may be written in any manner. In one embodiment, a tagged region may be used to store any (and only) files that have been tagged.

As noted above, differentiated storage decisions and operations may be performed at any stage in a path through the storage stack to the target storage device where indicia of the tagged blocks is stored. In one embodiment, the storage system module 142 stores the set of block identifiers 174. If the storage system module 142 implements virtual disks, then storage system module may make choices regarding which backing store to use, which virtual disk file/container to use, etc.

Embodiments may be implemented where indicia of the tagged blocks is not persisted and may be safely lost if the host machine is shutdown, crashes, or otherwise loses state information. Note that the term “host machine”, as used herein, refers to both physical machines and virtual machines. Consider a SCSI-based embodiment where region or block tagging is used for the operating system's swap file. To use the tagging feature, the operating system opens a swap file shortly after its boot process starts. The operating system issues a trim or unmap command for the swap file, which logically discards any previous data in the swap file. That command flows down through the file system and any intermediary storage layers to the target storage device where the trim or unmap command is executed. The operating system then issues a file system control (fsctl) command directed to the swap file to indicate that the swap file is a special file (e.g., a file that will have a special storage contract). The storage stack may perform various internal management operations such as issuing a SCSI inquiry command, checking the target device's VDP, issuing a mode-sense command, etc. Various management operations may be performed, such as selecting or creating a backing store specifically for the swap file (e.g., a separate VHD) and storing a list of relevant blocks. For efficiency the blocks may be encoded as a linked list where each node in the list identifies a starting block and a length. When writes to the swap file by the file system (or memory manager) are issued, a block to be written is handled as described above. In the event of a crash of the host machine, ordinary untagged blocks persist. If the backing store holding the blocks for the tagged swap file is non-durable, there is no problem because the swap file contents will have become moot.

To elaborate, by identifying the extents of the swap file within various virtual disk files (e.g., VHD files) attached to a machine, and by passing that information down the storage stack to the virtual disk, it becomes possible to identify paging I/O and treat it differently than other I/O that might be destined for the same storage device. When the machine is a virtual machine, this can be done for any guest operating system, for example, as part of a guest operating system's virtualization (i.e., enlightenment) integration services. In some versions of the Microsoft Windows operating system, existing integration services in the file system layers and the block storage layers can be modified. Converting such operating system features into a custom SCSI CDB (Command Descriptor Block) is a convenient way to pass tagging functionality down through any lower layers of the virtual disk or storage stack.

Within a disk virtualization stack (e.g., a VHD stack), swap file extents can be tagged as unnecessary for replication. In one embodiment, the disk virtualization stack creates a separate VHD file, for instance named “pagefile-[unique-identifier].vhdx.” This separate VHD file would receive all swap file I/O for the operating system. The VHD file may be dynamically expanding, with the same dimensions as the VHD from which it was derived (e.g., same block size, same virtual disk size, etc.). Once this secondary swap file VHD is open, all the corresponding ranges in the primary VHD may be trimmed, so that the total size on disk for the two VHDs is the same as the size on disk for a single VHD, plus an extra set of VHD metadata for the swap file VHD.

Building a new VHD each time a machine boots would be feasible but would increase the boot time. To optimize, the swap file VHD may be left in place between boots (e.g., when a machine shuts down), with its contents possibly being trimmed for space usage and security reasons.

When a host (physical or virtual) hosting an operating system crashes, crash data is written into the swap file and the host is rebooted. Preserving this data may be helpful for diagnostics. Therefore, in some embodiments, page file data is deleted unless the operating system determines that the host shut down cleanly. This might be as simple as trimming the data if the host shut down completely and leaving it in place if the host reboots itself. This might also be a helpful performance optimization. In any case, another custom CDB may be sent through the stack when writing a crash dump, thus indicating that the tagged data should be preserved.

In embodiments where the operating system's immediate host is a virtual machine, by splitting the paging data into a separate VHD file, whole-VM snapshots can continue to work as expected, with a differencing disk chain created for the swapping VHDs just as such chains are created are for other VHD files. Storage migration may work in a similar fashion.

By splitting the swap file into a separate VHD file, separate caching policies can be applied. Instead of forcing all writes through to the media, it becomes possible to allow writes to be cached in host RAM and lazily written to the VHD, if written at all. This can reduce the load on the underlying storage subsystem and can make reads from the page file less expensive when the data to be read happens to still be in RAM. This would effectively extend the guest operating system's file system cache into the host machine's RAM, which would make it possible to trim that cache without the guest's cooperation. This might make it possible to assign less total RAM to the virtual machine, as paging I/O could be (with correct administration of RAM allocation) made to be statistically cheaper, reducing the RAM needed within the VM for file caching.

In another embodiment, tagging of a region by software can be used to provide quality of service features. While deciding which part of a storage device will store a tagged region can be useful, performance or quality of service features may also implemented to take advantage of region tagging. In one embodiment, a storage device may provide differentiated levels of throughput, latency, transactions per second, etc., based on whether blocks are in a described or tagged region. Other functions of the storage device may also take into account block tagging. For example, operations related to flushing data from volatile cache storage to non-volatile media, error checking, access priority, or others may be performed in a manner that allows a storage device to provide differentiated performance with respect to tagged blocks. Storage performance may also be implemented in the storage stack, for example in a SCSI subsystem, which may prioritize paths, regulate bus bandwidth, and so forth based on whether storage data corresponds to a tagged region.

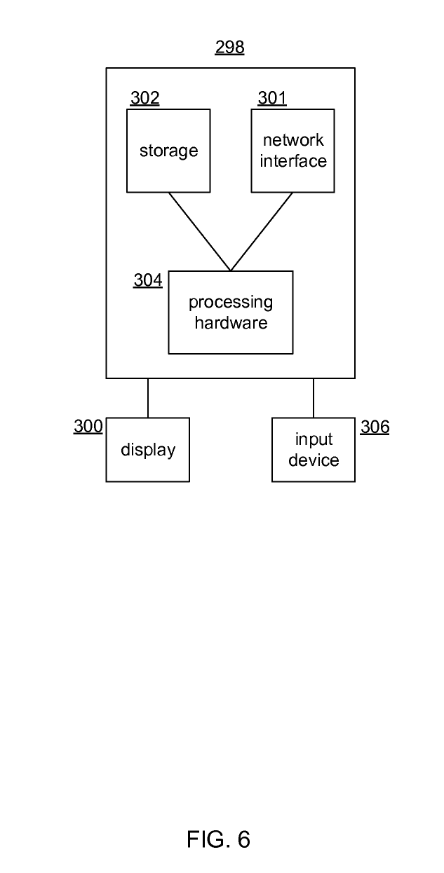

FIG. 6 shows details of a computing device 298 on which embodiments described above may be implemented. The computing device 298 may have a display 300, a network interface 301, as well as storage 302 and processing hardware 304, which may be a combination of any one or more: central processing units, graphics processing units, analog-to-digital converters, bus chips, Field-programmable Gate Arrays (FPGAs), Application-specific Integrated Circuits (ASICs), Application-specific Standard Products (ASSPs), or Complex Programmable Logic Devices (CPLDs), etc. The storage 302 may be any combination of magnetic storage, static memory, volatile memory, etc. The meaning of the term “storage”, as used herein does not refer to signals or energy per se, but rather refers to physical apparatuses, possibly virtualized, including physical media such as magnetic storage media, optical storage media, static memory devices, etc., but not signals per se. The hardware elements of the computing device 298 may cooperate in ways well understood in the art of computing. In addition, input devices 306 may be integrated with or in communication with the computing device 298. The computing device 298 may have any form factor or may be used in any type of encompassing device. The computing device 298 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable apparatuses, with such information able to configure the computing device 298, when operating, to perform the embodiments described herein. These apparatuses may include apparatuses such as optical storage (e.g., compact-disk read-only memory (CD-ROM)), magnetic media, holographic storage, flash read-only memory (ROM), or other devices for storing digital information. The stored information can be in the form of machine executable instructions (e.g., compiled executable binary code), source code, bytecode, or other information that can be used to enable or configure computing devices to perform the embodiments described herein. This is also deemed to include at least volatile memory such as random-access memory (RAM) and/or virtual memory storing information such as central processing unit (CPU) instructions during execution of software carrying out an embodiment, as well as non-volatile devices storing information that allows a program or executable to be loaded and executed.

1. A method of managing block-based storage devices, the method performed by a computing device comprising processing hardware and a block-based storage device, the method comprising:
executing an operating system comprising a storage stack, the storage stack comprising a file system, a device driver driving the block-based storage device, and a storage component intermediating between the device driver and the file system;
receiving, by the file system, a request to tag a file managed by the file system and stored on the storage device, in response the file system requesting the storage component to tag blocks corresponding to the file, the device driver forwarding the request from the storage component to the storage device; and
in response to the request from the device driver, storing, by the storage device, indicia of the blocks, wherein, based on the indicia of the blocks, the storage device selects a backing store for the blocks.

2. A method according to claim 1, wherein the storage device implements commands of a version or extension of the Small Computer System Interface (SCSI) standard.

3. A method according to claim 2, wherein the request from the device driver comprises a mode-select SCSI command.

4. A method according to claim 1, wherein the storing comprises persisting the indicia of the blocks.

5. A method according to claim 1, further comprising querying the storage device, by the storage component, to determine whether the storage device supports tagging.

6. A method according to claim 1, further comprising determining whether to copy from, duplicate from, or retain data stored in, the storage device, wherein the determining is based on whether the data corresponds to tagged blocks.

7. A computing device comprising:
processing hardware and memory, that, when the computing device is operating, execute an operating system comprising a storage stack;
the storage stack intermediating requests to and from a block-based storage device managed by the operating system;
the storage stack receiving a request to tag a region of storage maintained by the storage device, and in response the storage device being provided with indicia of blocks corresponding to the region, wherein the storage device provides differentiated storage based on the indicia of the blocks, and wherein when writes of blocks are received by the storage device, and wherein the storage device selects a backing store for the blocks based on whether the blocks are determined to be in the set of blocks identified by the indicia.

8. A computing device according to claim 7, wherein the operating system comprises an application programming interface (API) used to generate the request to tag the file.

9. A computing device according to claim 7, wherein the differentiated storage comprises prioritizing operations for reads and writes of blocks according to whether the blocks correspond to tagged blocks.

10. A computing device according to claim 9, wherein the prioritizing corresponds to latency or throughput of the reads and writes of the blocks.

11. A computing device according to claim 7, wherein a backup of the storage device is informed by the indicia of the blocks.

12. A computing device according to claim 7, wherein a data recovery operation to recover data from the storage device is informed by the indicia of the blocks.

13. A computing device according to claim 7, wherein the storage device comprises a virtual disk provided by either a hypervisor executing on the computing device, or a virtual disk service of the operating system, or a storage area network (SAN).

14. A computing device according to claim 7, wherein the storage device comprises a first backing store comprising a first type or unit of storage and a second backing store comprising a second type or unit of block storage, and the selecting the backing store comprises determining whether to store blocks in the first backing store or the second backing store.

15. A computing device comprising:
processing hardware and memory, that, when the computing device is operating, together execute an operating system;
a storage device that, when the computing device is operating, provides block-based storage of blocks through a storage stack of the operating system;
the storage device, when the computing device is operating, receives a description of a set of blocks through the storage stack and in response stores indicia of the set of blocks, the description initiated through a program instructing the operating system to associate the description with a region of storage maintained by the storage device, the region corresponding to the set of blocks; and
the storage device, when the computing device is operational, receives blocks to write and stores the blocks by determining whether the blocks are included in the set of blocks.

16. A computing device according to claim 15, wherein the storage device comprises a virtual disk file formatted according to a virtual disk format.

17. A computing device according to claim 16, wherein the operating system comprises a file system that manages a file corresponding to the region, and wherein the virtual disk file is comprised of a first storage region in the file and a second storage region in the file, the first storage region for storing blocks of only the file or of only files managed by the file system that have been tagged.

18. A computing according to claim 16, wherein the storage device further comprises:
a second virtual disk file,
wherein the storage devices stores a plurality of files comprising the file and other files,
wherein the virtual disk file stores all blocks of the file, or other tagged files, and stores no blocks of the other files, and
wherein the second virtual disk file stores no blocks of the file or other tagged files, and stores all blocks of the other files.

19. A computing device according to claim 15, wherein the indicia is not persisted such that if the operating system does not shut down cleanly the indicia becomes lost, deleted, or inaccessible.

20. A computing device according to claim 15, wherein the storage device comprises a memory cache and a non-volatile media, and wherein commits of blocks from the memory cache to the non-volatile media by the storage device are made by the storage device determining whether blocks to be committed are in the set of blocks.
